(19) United States
(12) Patent Application Publication
(10) Pub. No.: US 2021/0199424 A1
(43) Pub. Date: Jul. 1, 2021

(54) MACHINE TOOL AND ELECTRIC DISCHARGE MACHINING APPARATUS

(71) Applicant: Mitsubishi Electric Corporation, Tokyo (JP)

(72) Inventors: Hiroki GOTO, Tokyo (JP); Kiyoshi ONOHARA, Tokyo (JP); Masaharu IMAKI, Tokyo (JP); Naoki SUZUKI, Tokyo (JP); Takayuki YANAGISAWA, Tokyo (JP)

(73) Assignee: Mitsubishi Electric Corporation, Tokyo (JP)

(21) Appl. No.: 17/198,523

(22) Filed: Mar. 11, 2021

Related U.S. Application Data
(63) Continuation of application No. PCT/JP2019/036394, filed on Sep. 17, 2019.

(30) Foreign Application Priority Data
Oct. 5, 2018 (JP) PCT/JP2018/037409

(51) Int. Cl. G01B 11/24; B23H 7/32

(52) U.S. Cl. CPC G01B 11/2441; B23H 2500/20; B23H 7/32

(57) ABSTRACT

A machine tool includes a machining unit for feeding cutting oil to a work surface of a workpiece and machining the work surface, an optical sensor body unit dividing light outputted from a frequency sweep light source for outputting light whose frequency varies periodically into irradiation light with which the workpiece is to be irradiated and reference light, irradiating the workpiece with the irradiation light, detecting a peak frequency of interference light between reflected light which is irradiation light reflected by the workpiece, and the reference light, and measuring the distance from the machine tool to the work surface on the basis of the peak frequency, and a shape calculation unit calculating the shape of the workpiece on the basis of the distance measured by the optical sensor body unit.

### CROSS REFERENCE TO RELATED APPLICATIONS

This application is a Continuation of PCT International Application No. PCT/JP2019/036394, filed on Sep. 17, 2019, which claims priority under 35 U.S.C. 119(a) to Patent Application No. PCT/JP2018/037409, filed in Japan on Oct. 5, 2018, all of which are hereby expressly incorporated by reference into the present application.

### TECHNICAL FIELD

The present invention relates to a machine tool for and an electric discharge machining apparatus for machining a work surface of a workpiece.

### BACKGROUND ART

Conventionally, machine tools that machine an object and measure the surface shape of a machined work surface of the object after machining have been known (refer to Patent Literature 1). A machine tool described in Patent Literature 1 is configured so as to measure the surface shape of a machined work surface on the basis of changes in the intensity of reflected light.

Because an optical sensor cannot receive reflected light properly in a state in which cutting oil applied at the time of machining is adhered to the work surface, in the machine tool described in Patent Literature 1, the cutting oil adhered to the work surface is removed by blowing the cutting oil off the work surface before the measurement of the shape.

### CITATION LIST

### Patent Literature

Patent Literature 1: JP 2018-36083 A

### SUMMARY OF INVENTION

### Technical Problem

However, in order to remove the cutting oil completely, it is necessary to blow the cutting oil off the work surface for a long time. In order to shorten the time required to measure the shape, it is desirable that the surface shape of the work surface can be measured even in the state in which the cutting oil remains on the work surface.

The present invention is made in order to solve the above-described problem, and it is therefore an object of the present invention to obtain a machine tool that can measure the shape of a workpiece even in a case in which cutting oil remains on a work surface of the workpiece.

### Solution to Problem

A machine tool according to the present invention includes a machining unit for feeding cutting oil to a work surface of a workpiece and machining the work surface, and is configured so as to include: an optical sensor unit for dividing light outputted from a frequency sweep light source for outputting light whose frequency varies periodically into irradiation light with which the workpiece is to be irradiated and reference light, irradiating the workpiece with the irradiation light, detecting a peak frequency of interference light between reflected light which is irradiation light reflected by the workpiece, and the reference light, and measuring the distance from the machine tool to the work surface on the basis of the peak frequency; and a shape calculation unit for calculating the shape of the workpiece on the basis of the distance measured by the optical sensor unit.

### Advantageous Effects of Invention

The machine tool according to the present invention can measure the shape of the workpiece even in a case in which cutting oil remains on the work surface of the workpiece.

### BRIEF DESCRIPTION OF DRAWINGS

FIG. 1 is a schematic diagram showing a machine tool according to Embodiment 1;

FIG. 2 is a schematic diagram showing an optical sensor unit 20 according to Embodiment 1;

FIG. 3 is an explanatory drawing showing an example of frequency sweep light;

FIG. 4 is an explanatory drawing showing the reflection of irradiation light on a work surface 3a, and the reflection of the irradiation light on cutting oil;

FIG. 5 is a hardware block diagram of a computer in a case in which a distance calculation unit 40 is implemented by software, firmware, or the like;

FIG. 6 is a schematic diagram showing a control unit 50 of the machine tool according to Embodiment 1;

FIG. 7A is an explanatory drawing showing an initial distance L₀ which is the distance from a leading end 21a of a sensor head unit 21 to the position of a work surface 3a in a state in which no machining of the work surface 3a is performed;

FIG. 7B is an explanatory drawing showing a distance L from the leading end 21a of the sensor head unit 21 to the position of the work surface 3a in a state in which machining of the work surface 3a has been performed;

FIG. 8 is a hardware block diagram showing the hardware of a part of the control unit 50;

FIG. 9 is a hardware block diagram of a computer in a case in which a part of the control unit 50 is implemented by software, firmware, or the like;

FIG. 10 is a flowchart showing a procedure when the machine tool measures the shape of a work surface 3a of a workpiece 3;

FIG. 11 is a flowchart showing a process of calculating the distance in a sensor body unit 22;

FIG. 12 is an explanatory drawing showing an example of signals in a frequency domain;

FIG. 13 is a schematic diagram showing a machine tool according to Embodiment 2;

FIG. 14 is a schematic diagram showing a sensor head unit 21b of Embodiment 2;

FIG. 15 is a block diagram showing a machine tool according to Embodiment 3;

FIG. 16 is a schematic diagram showing a machine tool according to Embodiment 4;

FIG. 17 is a partly enlarged view showing the machine tool according to Embodiment 4; and

FIG. 18 is a schematic diagram showing a machine tool according to Embodiment 5.

### DESCRIPTION OF EMBODIMENTS

Hereinafter, in order to explain the present invention in greater detail, embodiments of the present invention will be described with reference to the accompanying drawings.

### Embodiment 1

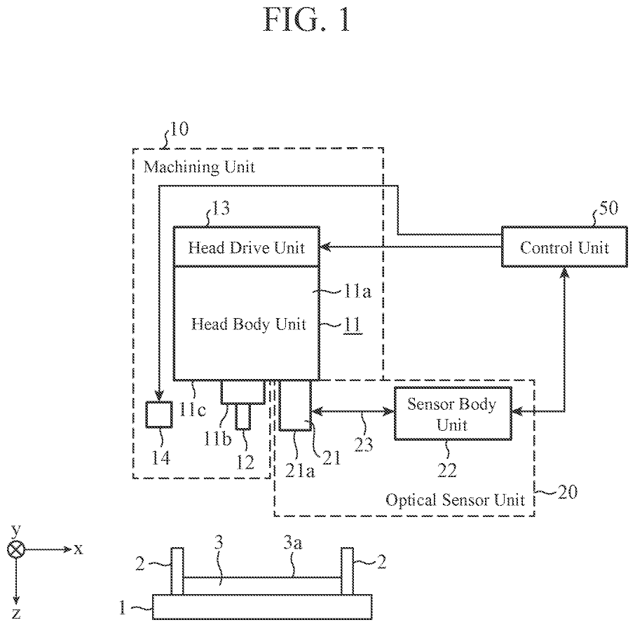

FIG. 1 is a schematic diagram showing a machine tool according to Embodiment 1. In FIG. 1, a table 1 is a base on which a workpiece 3 which is an object to be machined is placed. Vices 2 are fixtures for fixing the workpiece 3 so that the workpiece 3 does not move at the time of machining the workpiece 3. The workpiece 3 is a piece of metal or the like whose work surface 3a is to be machined by a machining unit 10. In Embodiment 1, for the sake of simplicity of the explanation, it is assumed that the work surface 3a before machining by the machining unit 10 is plane.

The machining unit 10 includes a machining head 11, a machining tool 12, a head drive unit 13, and a cutting oil nozzle 14. The machining unit 10 feeds cutting oil to the work surface 3a of the workpiece 3, and machines the work surface 3a.

The machining head 11 includes a head body unit 11a and a spindle 11b which is a tool holding unit. The head body unit 11a is a metallic structure for supporting the spindle 11b. The spindle 11b is a metallic shaft-shaped part which includes a not-illustrated chuck device for attachably/detachably holding the machining tool 12 and which rotationally moves in a state of holding the machining tool 12. Further, a sensor head unit 21 which is a part of an optical sensor unit 20 is mounted on the head body unit 11a.

The machining tool 12 is a cutting tool for cutting the work surface 3a of the workpiece 3 through its rotating operation, and is an edged tool for metal processing, such as a milling cutter, an end mill, a drill, or a tap.

The head drive unit 13 is a drive mechanism for relatively changing the position of the head body unit 11a with respect to the work surface 3a in accordance with a control signal outputted from a control unit 50. The direction of the change of the position of the head body unit 11a, the change being performed by the head drive unit 13, is the x-axis direction, the y-axis direction, or the z-axis direction which is shown in FIG. 1.

The cutting oil nozzle 14 applies the cutting oil to the work surface 3a of the workpiece 3 when receiving an instruction to feed the cutting oil from the control unit 50.

The optical sensor unit 20 includes the sensor head unit 21, a sensor body unit 22, and an optical transmission unit 23. The optical sensor unit 20 is a sensor for calculating the distance from a leading end 21a of the sensor head unit 21 to the work surface 3a machined by the machining unit 10.

The sensor head unit 21 is mounted on an outer surface 11c facing the table 1, out of multiple outer surfaces which the head body unit 11a has. The sensor head unit 21 emits irradiation light outputted from the sensor body unit 22 toward the work surface 3a, and receives reflected light containing both reflected light which is irradiation light reflected by the work surface 3a and reflected light which is irradiation light reflected by the cutting oil. The sensor head unit 21 outputs the reflected light received thereby to the sensor body unit 22.

The sensor body unit 22 calculates the distance from the leading end 21a of the sensor head unit 21 to the work surface 3a, and outputs distance information showing the calculated distance to the control unit 50.

The optical transmission unit 23 is a transmission path for light heading for the sensor head unit 21 from the sensor body unit 22, and light heading for the sensor body unit 22 from the sensor head unit 21, and includes an optical fiber. Although in the machine tool of Embodiment 1 the optical transmission unit 23 is disposed, the optical transmission unit 23 is not necessarily needed. In the case in which the optical transmission unit 23 is not disposed, light can be transmitted via space.

The control unit 50 outputs a control signal showing the position to which the head body unit 11a is to be moved to the head drive unit 13, and outputs an instruction to feed the cutting oil to the cutting oil nozzle 14. The control unit 50 calculates the shape of the work surface 3a from both the position of the head body unit 11a, the position being changed by the head drive unit 13, and the distance represented by the distance information outputted from the sensor body unit 22.

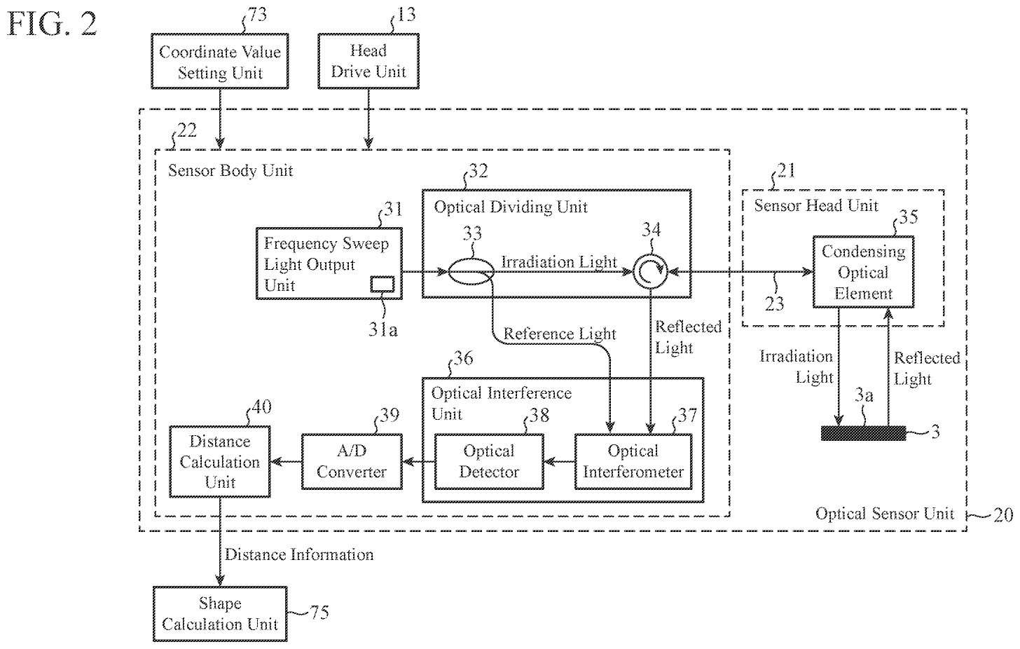

Next, the configuration of the optical sensor unit 20 will be explained using FIG. 2. FIG. 2 is a schematic diagram showing the optical sensor unit 20 according to Embodiment 1. The optical sensor unit 20 includes a frequency sweep light output unit 31, an optical dividing unit 32, an optical interference unit 36, an analog to digital converter (referred to as an “A/D converter” hereinafter) 39, and a distance calculation unit 40, as shown in FIG. 2.

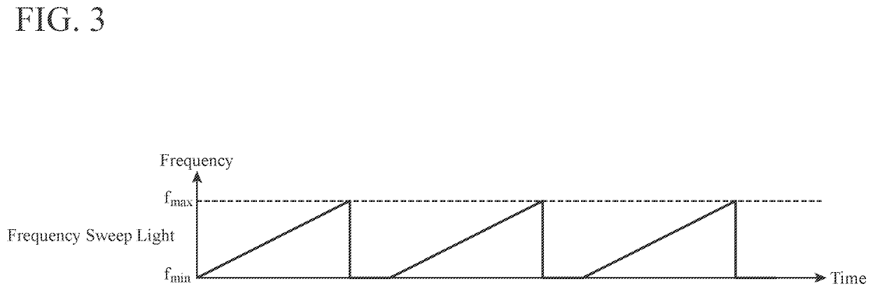

In FIG. 2, the frequency sweep light output unit 31 includes a frequency sweep light source 31a for outputting frequency sweep light whose frequency varies with time within a single frequency band. The single frequency band ranges from a minimum frequency f_{MIN} to a maximum frequency Fₘₐₓ. The frequency sweep light output unit 31 outputs the frequency sweep light to the optical dividing unit 32. FIG. 3 is an explanatory drawing showing an example of the frequency sweep light. The frequency sweep light is a signal whose frequency varies from the minimum frequency fₘᵢₙ to the maximum frequency fₘₐₓ with time. When the frequency of the frequency sweep light reaches the maximum frequency fₘₐₓ, the frequency returns to the minimum frequency fₘᵢₙ at that time and, after that, varies from the minimum frequency fₘᵢₙ to the maximum frequency fₘₐₓ again. The frequency sweep light may be referred to as chirp signal light.

The optical dividing unit 32 includes an optical coupler 33 and a circulator 34. The optical coupler 33 is a light dividing element for dividing the frequency sweep light outputted from the frequency sweep light output unit 31 into reference light and irradiation light. The optical coupler 33 outputs the reference light to an optical interferometer 37 and outputs the irradiation light to the circulator 34.

The circulator 34 outputs the irradiation light outputted from the optical coupler 33 to a condensing optical element 35 of the sensor head unit 21 via the optical transmission unit 23. Further, the circulator 34 outputs the reflected light outputted from the condensing optical element 35 to the optical interferometer 37.

The sensor head unit 21 has the condensing optical element 35. The condensing optical element 35 condenses the irradiation light outputted from the circulator 34 onto the work surface 3a. Concretely, the condensing optical element 35 includes two aspheric lenses, and forms the light outputted from the circulator 34 into collimated light by using a previous-stage aspheric lens and, after that, condenses the collimated light by using a next-stage aspheric lens and applies the condensed light to the work surface 3a.

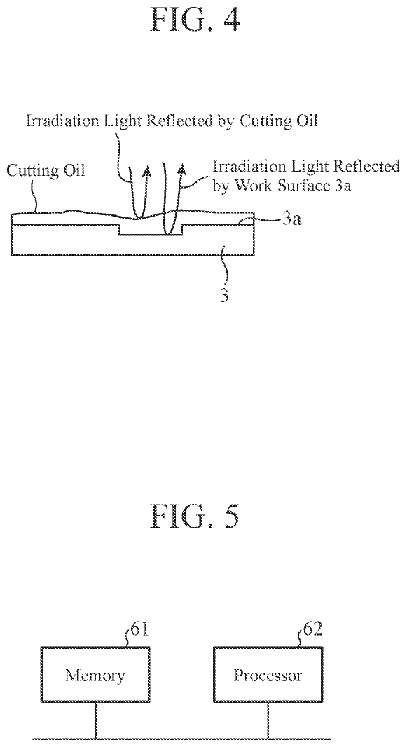

FIG. 4 is an explanatory drawing showing the reflection of the irradiation light on the work surface 3a and the reflection of the irradiation light on the cutting oil. The irradiation light outputted from the condensing optical element is not only reflected by the work surface 3a, but also reflected by the cutting oil, as shown in FIG. 4.

Returning to FIG. 2, the condensing optical element 35 receives the reflected light containing both the reflected light from the work surface 3a and the reflected light from the cutting oil. The condensing optical element 35 outputs the reflected light received thereby to the circulator 34 via the optical transmission unit 23. The circulator 34 outputs the reflected light outputted from the condensing optical element to the optical interferometer 37.

The optical interference unit 36 includes the optical interferometer 37 and an optical detector 38. The optical interference unit 36 generates interference light between the reflected light received by the sensor head unit 21 and the reference light, and converts the interference light into an electric signal and outputs the electric signal to the A/D converter 39.

The reflected light outputted from the circulator 34 and the reference light outputted from the optical coupler 33 are made to be incident on the optical interferometer 37. The optical interferometer 37 generates interference light between the reflected light and the reference light. Because the reflected light from the workpiece contains the reflected light from the work surface 3a and the reflected light from the cutting oil as described above, the interference light generated by the optical interferometer 37 also contains work surface interference light (first interference light) which is interference light between the reflected light from the work surface 3a and the reference light, and cutting oil interference light (second interference light) which is interference light between the reflected light from the cutting oil and the reference light.

The optical detector 38 detects the interference light containing both the work surface interference light and the cutting oil interference light, and converts the interference light into an electric signal. The optical detector 38 outputs the electric signal to the A/D converter 39.

The A/D converter 39 converts the electric signal outputted from the optical detector 38 from an analog signal into a digital signal, and outputs the digital signal to the distance calculation unit 40.

The distance calculation unit 40 analyzes the frequencies of the interference light generated by the optical interference unit 36 by converting the digital signal outputted from the A/D converter 39 into signals in a frequency domain, and calculates a distance L from the leading end 21a of the sensor head unit 21 to the work surface 3a on the basis of a result of the analysis of the frequencies. Concretely, the distance calculation unit distinguishes between the frequency of the work surface interference light and the frequency of the cutting oil interference light, and calculates the distance L from the leading end 21a of the sensor head unit 21 to the work surface 3a on the basis of the frequency of the work surface interference light. The distance calculation unit 40 outputs distance information showing the calculated distance L to a shape calculation unit 75 of the control unit 50.

The distance calculation unit 40 is implemented by, for example, a distance calculation circuit not illustrated. The distance calculation circuit is, for example, a single circuit, a composite circuit, a programmable processor, a parallel programmable processor, an application specific integrated circuit (ASIC), a field-programmable gate array (FPGA), or a combination of these circuits.

Further, although the example in which the distance calculation unit 40 is implemented by the distance calculation circuit which is hardware for exclusive use is shown here, no limitation is intended to this example, and the distance calculation unit may be implemented by software, firmware, or a combination of software and firmware. The software or the firmware is stored as a program in a memory of a computer. The computer refers to hardware that executes a program, and includes, for example, a central processing unit (CPU), a central processing device, a processing device, an arithmetic device, a microprocessor, a microcomputer, a processor, or a digital signal processor (DSP). FIG. 5 is a hardware block diagram of the computer in the case in which the distance calculation unit 40 is implemented by software, firmware, or the like. In the case in which the distance calculation unit is implemented by software, firmware, or the like, a program for causing the computer to perform a processing procedure of the distance calculation unit 40 is stored in a memory 61. A processor 62 of the computer then executes the program stored in the memory 61.

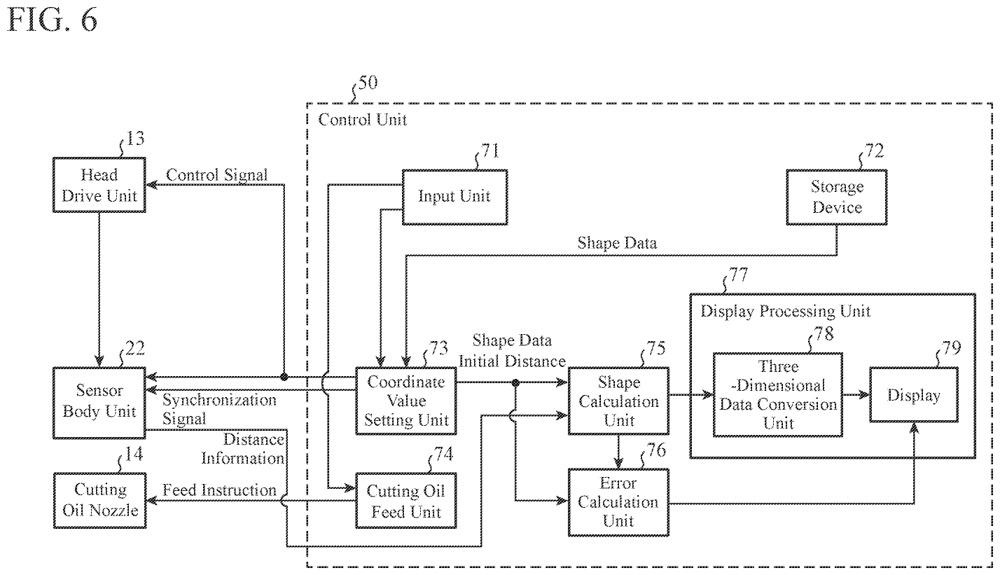

Next, the configuration of the control unit 50 will be explained using FIG. 6. FIG. 6 is a schematic diagram showing the control unit 50 of the machine tool according to Embodiment 1.

An input unit 71 receives an instruction from a user to feed the cutting oil, an instruction from a user to machine the workpiece 3, an instruction from a user to measure the shape of the workpiece 3, or the like. The input unit 71 is implemented by a man-machine interface such as operation buttons.

A storage device 72 stores shape data showing the target shape of the work surface 3a. The shape data contains data showing the coordinate values (x, y) of each of multiple points on the work surface 3a and data showing depth information d about each of the multiple points. The depth information d shows a cutting depth from the plane which is the work surface 3a in a state in which no machining is yet performed. The target shape is, for example, designed by a user as the shape of the work surface 3a after the machining. The storage device 72 is implemented by, for example, a hard disc.

When an instruction to machine the workpiece 3 or an instruction to measure the shape of the workpiece 3 is received by the input unit 71, a coordinate value setting unit 73 acquires the shape data stored in the storage device 72. The coordinate value setting unit 73 generates a control signal showing the position to which the head body unit 11a is to be moved on the basis of the acquired shape data. The movement position of the head body unit 11a is expressed by coordinate values (x, y).

When an instruction to machine the workpiece 3 is received by the input unit 71, the control signal generated by the coordinate value setting unit 73 contains the depth information d about the point expressed by the coordinate values (x, y). The head drive unit 13 moves the head body unit 11a to the movement position represented by the control signal generated by the coordinate value setting unit 73 and, after that, moves the head body unit 11a along the z-axis direction on the basis of the depth information d.

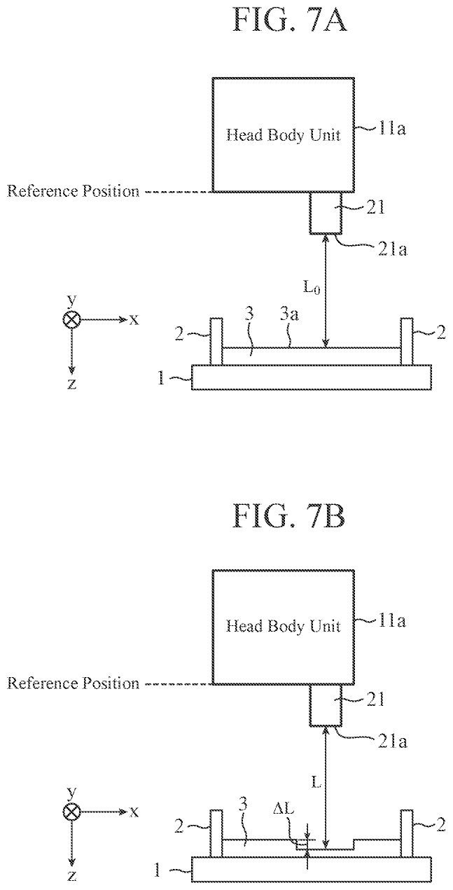

On the other hand, when an instruction to measure the shape of the workpiece 3 is received by the input unit 71, the control signal generated by the coordinate value setting unit 73 contains, for example, information for moving the position in the z-axis direction of the head body unit 11a to a reference position. The reference position is the position of the head body unit 11a in the z-axis direction at the time of measuring the shape of the work surface 3a, and is given in the coordinate value setting unit 73. When the head body unit 11a is located at the reference position, the distance from the leading end 21a of the sensor head unit 21 to the position of the work surface 3a is L₀, as shown in FIG. 7A, and L₀ is referred to as the initial distance hereinafter. The initial distance L₀ is also given in the coordinate value setting unit 73. FIG. 7A is an explanatory drawing showing the initial distance L₀ which is the distance from the leading end 21a of the sensor head unit 21 to the position of the work surface 3a in a state in which no machining of the work surface 3a is performed. FIG. 7B is an explanatory drawing showing the distance L from the leading end 21a of the sensor head unit 21 to the position of the work surface 3a in a state in which machining of the work surface 3a has been performed.

Returning to FIG. 6, the head drive unit 13 which has received the control signal moves the head body unit 11a to the movement position represented by the control signal generated by the coordinate value setting unit 73 and, after that, moves the head body unit 11a along the z-axis direction in such away that the position of the head body unit 11a in the z-axis direction becomes the reference position.

Further, when an instruction to measure the shape of the workpiece 3 is received by the input unit 71 and a control signal is transmitted to the head drive unit 13, the coordinate value setting unit 73 transmits a synchronization signal, which is a trigger for causing frequency sweep light to be emitted from the frequency sweep light source 31a, to the sensor body unit 22. In addition, when an instruction to measure the shape of the workpiece 3 is received by the input unit 71, the coordinate value setting unit 73 outputs the shape data and the initial distance L₀ to each of the shape calculation unit 75 and an error calculation unit 76.

When an instruction to feed the cutting oil is received by the input unit 71, a cutting oil feed unit 74 outputs an instruction to feed the cutting oil, the instruction showing that the cutting oil is to be applied to the work surface 3a, to the cutting oil nozzle 14.

The shape calculation unit 75 calculates the difference between the initial distance L₀ outputted from the coordinate value setting unit 73 and the distance L represented by the distance information outputted from the distance calculation unit 40, as a cutting depth ΔL (=L-L₀) of the work surface 3a. The shape calculation unit 75 outputs data containing both the data showing the coordinate values (x, y) of each of the multiple points and the cutting depth ΔL, which are contained in the shape data, as data (x, y, ΔL) showing the shape of the work surface 3a, to each of the error calculation unit 76 and a three-dimensional data conversion unit 78.

The error calculation unit 76 calculates an error Δd between the shape calculated by the shape calculation unit 75 and the target shape of the work surface 3a. For example, the error calculation unit 76 compares the shape data (x, y, d) outputted from the coordinate value setting unit 73 and the data (x, y, ΔL) outputted from the shape calculation unit 75 and showing the shape, and calculates an error Δd (=d-ΔL) in the z-axis direction of each of the multiple points on the work surface 3a. The error calculation unit 76 outputs error information showing the error Δd in the z-axis direction of each of the multiple points to a display 79.

A display processing unit 77 includes the three-dimensional data conversion unit 78 and the display 79.

The three-dimensional data conversion unit 78 converts the data (x, y, ΔL) outputted from the shape calculation unit 75 into three-dimensional data, and causes the display 79 to display the work surface 3a in three dimensions in accordance with the three-dimensional data. The three-dimensional data is used for three-dimensional rendering.

The display 79 is implemented by, for example, a liquid crystal display. The display 79 displays the work surface 3a in three dimensions, and also displays the error Δd represented by the error information outputted from the error calculation unit 76.

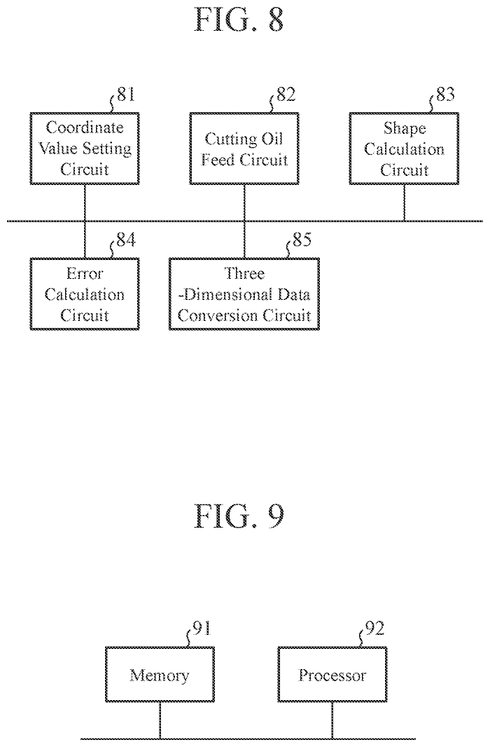

FIG. 8 is a hardware block diagram showing the hardware of a part of the control unit 50. As shown in FIG. 8, the coordinate value setting unit 73 is implemented by a coordinate value setting circuit 81, the cutting oil feed unit 74 is implemented by a cutting oil feed circuit 82, the shape calculation unit 75 is implemented by a shape calculation circuit 83, the error calculation unit 76 is implemented by an error calculation circuit 84, and the three-dimensional data conversion unit 78 is implemented by a three-dimensional data conversion circuit 85.

Here, it is assumed that each of the following units: the coordinate value setting unit 73, the cutting oil feed unit 74, the shape calculation unit 75, the error calculation unit 76, and the three-dimensional data conversion unit 78, which are the components of the part of the control unit 50, is implemented by hardware for exclusive use as shown in FIG. 8. More specifically, the example in which the part of the control unit 50 is implemented by the coordinate value setting circuit 81, the cutting oil feed circuit 82, the shape calculation circuit 83, the error calculation circuit 84, and the three-dimensional data conversion circuit 85 is shown. However, no limitation is intended to this example, and a part of the control unit 50 may be implemented by software, firmware, or a combination of software and firmware.

FIG. 9 is a hardware block diagram of a computer in the case in which the part of the control unit 50 is implemented by software, firmware, or the like. In the case in which the part of the control unit 50 is implemented by software, firmware, or the like, programs for causing the computer to perform processing procedures of the coordinate value setting unit 73, the cutting oil feed unit 74, the shape calculation unit 75, the error calculation unit 76, and the three-dimensional data conversion unit 78 are stored in a memory 91. A processor 92 of the computer executes the programs stored in the memory 91.

Next, the operation of the machine tool according to Embodiment 1 will be explained. First, the operation at the time that the machine tool cuts the work surface 3a of the workpiece 3 will be explained. Because the operation of cutting the work surface 3a is well known, the operation of cutting the work surface 3a will be explained briefly hereinafter.

The input unit 71 receives an instruction to feed the cutting oil from a user. When the input unit 71 receives an instruction to feed the cutting oil, the cutting oil feed unit 74 outputs an instruction to feed the cutting oil, this instruction showing that the cutting oil is to be applied to the work surface 3a, to the cutting oil nozzle 14. When receiving the instruction to feed the cutting oil from the cutting oil feed unit 74, the cutting oil nozzle 14 applies the cutting oil to the work surface 3a.

The input unit 71 receives an instruction to machine the workpiece 3 from the user. When the input unit 71 receives the instruction to machine, the coordinate value setting unit 73 acquires the shape data stored in the storage device 72.

The coordinate value setting unit 73 generates a control signal showing the position to which the head body unit 11a is to be moved on the basis of the shape data, and outputs the control signal to the head drive unit 13. Concretely, the coordinate value setting unit 73 selects one point from the multiple points on the work surface 3a, generates a control signal for moving the head body unit 11a to the coordinate values (x, y) of the one point selected, and outputs the control signal to the head drive unit 13. Then, when the cutting at the one point selected is completed, the coordinate value setting unit 73 selects one point at which the cutting is not completed yet, generates a control signal for moving the head body unit 11a to the coordinate values (x, y) of the one point selected, and outputs the control signal to the head drive unit 13. The coordinate value setting unit 73 repeatedly generates a control signal for moving the head body unit 11a until the cutting at all the points on the work surface 3a is completed.

Every time receiving a control signal from the coordinate value setting unit 73, the head drive unit 13 moves the head body unit 11a to the movement position represented by the control signal and, after that, moves the head body unit 11a along the z-axis direction on the basis of the depth information d contained in the control signal. The machining tool 12 held by the head body unit 11a cuts the work surface 3a through, for example, the rotating operation of the spindle 11b.

Here, when the input unit 71 receives an instruction to machine the workpiece 3 from a user, the cutting oil feed unit 74 outputs an instruction to feed the cutting oil to the cutting oil nozzle 14. However, this is only an example, and, for example, the cutting oil feed unit 74 may output an instruction to feed the cutting oil to the cutting oil nozzle 14 at fixed time intervals. As an alternative, a sensor for detecting the presence or absence of the cutting oil on the work surface 3a may be provided, and when the sensor detects that there is no cutting oil, the cutting oil feed unit 74 may output an instruction to feed the cutting oil to the cutting oil nozzle 14.

Further, here, when the input unit 71 receives an instruction to machine the workpiece 3 from a user, the coordinate value setting unit 73 outputs a control signal to the head drive unit 13. However, this is only an example, and, for example, when an instruction to machine the workpiece 3 is received from the outside, the coordinate value setting unit 73 may output a control signal to the head drive unit 13. As an alternative, the coordinate value setting unit 73 may output a control signal to the head drive unit 13 in accordance with a program stored in an internal memory.

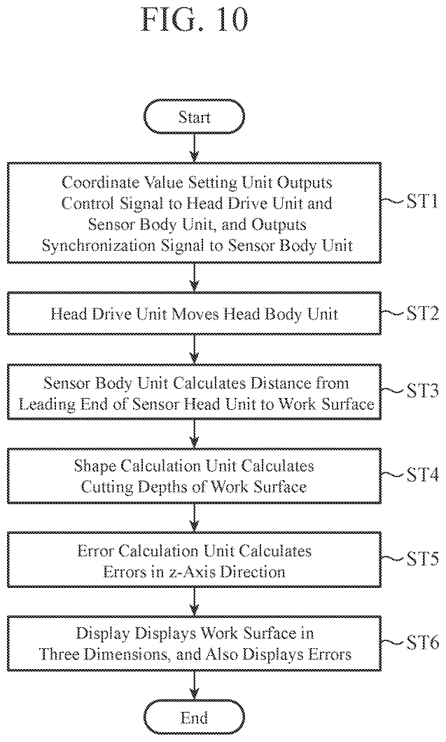

Next, the operation at the time that the machine tool measures the shape of the work surface 3a of the workpiece 3 will be explained. FIG. 10 is a flowchart showing a procedure at the time that the machine tool measures the shape of the work surface 3a of the workpiece 3.

The input unit 71 receives an instruction to measure the shape of the workpiece 3 from a user. When the input unit 71 receives an instruction to measure the shape, the coordinate value setting unit 73 acquires the shape data stored in the storage device 72. The coordinate value setting unit 73 generates a control signal showing the position to which the head body unit 11a is to be moved on the basis of the shape data, and outputs the control signal to each of the following units: the head drive unit 13 and the sensor body unit 22 (step ST1). Concretely, the coordinate value setting unit 73 selects one point from the multiple points on the work surface 3a, generates a control signal for moving the head body unit 11a to the coordinate values (x, y) of the one point selected, and outputs the control signal to the head drive unit 13. The coordinate value setting unit 73 also outputs a synchronization signal to the sensor body unit 22 (step ST1).

When measurement of the distance with respect to the one point selected is completed, the coordinate value setting unit 73 selects one point on which measurement is not completed yet, generates a control signal for moving the head body unit 11a to the coordinate values (x, y) of the one point selected, and outputs the control signal to each of the head drive unit 13 and the sensor body unit 22. The coordinate value setting unit 73 repeatedly generates a control signal for moving the head body unit 11a until measurement of the distances with respect to all the points on the work surface 3a is completed.

Each control signal generated by the coordinate value setting unit 73 contains information for moving the position in the z-axis direction of the head body unit 11a to the reference position. When receiving a control signal from the coordinate value setting unit 73, the head drive unit 13 moves the head body unit 11a to the movement position represented by the control signal and, after that, moves the position in the z-axis direction of the head body unit 11a to the reference position (step ST2).

When receiving a notification showing that the movement is completed from the head drive unit 13 after receiving the synchronization signal from the coordinate value setting unit 73, the sensor body unit 22 starts the process of measuring the distance and calculates the distance L from the leading end 21a of the sensor head unit 21 to the work surface 3a (step ST3).

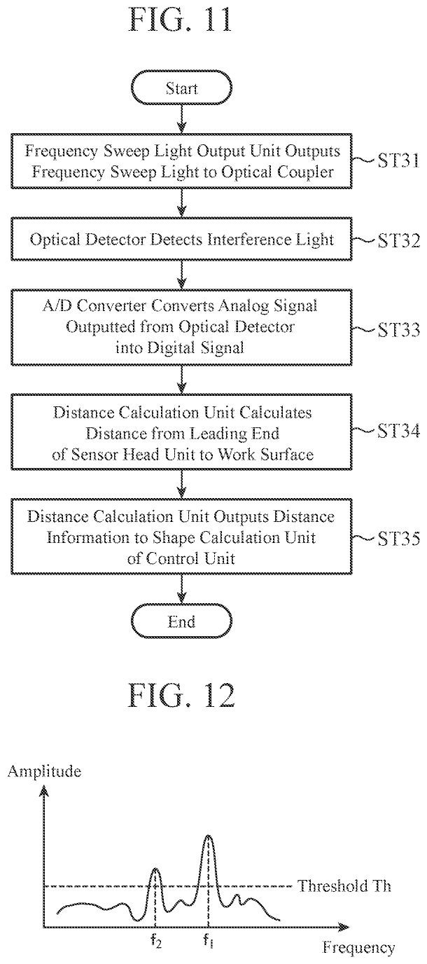

Hereinafter, the process of calculating the distance in the sensor body unit 22 will be explained concretely using FIG. 11. FIG. 11 is a flowchart showing the process of calculating the distance in the sensor body unit 22.

When receiving a notification showing that the movement is completed from the head drive unit 13 after receiving the synchronization signal from the coordinate value setting unit 73, the frequency sweep light output unit 31 outputs the frequency sweep light whose frequency varies with time to the optical coupler 33 (step ST31).

The frequency sweep light is divided into reference light and irradiation light by the optical coupler 33, and the irradiation light is outputted to the circulator 34 and the reference light is outputted to the optical interferometer 37. The irradiation light is made to be incident on the condensing optical element 35 via the circulator 34 and the optical transmission unit 23, and is condensed onto the work surface 3a by the condensing optical element 35.

Reflected light is made to be incident on the optical interferometer 37 via the condensing optical element 35, the optical transmission unit 23, and the circulator 34. The reflected light outputted from the circulator 34 and the reference light outputted from the optical coupler 33 interfere with each other at the optical interferometer 37, and the interference light is outputted to the optical detector 38.

The optical detector 38 detects the interference light outputted from the optical interferometer 37 (step ST32). The optical detector 38 converts the interference light into an electric signal and outputs this electric signal to the A/D converter 39.

When receiving the electric signal from the optical detector 38, the A/D converter 39 converts the electric signal from an analog signal into a digital signal (step ST33) and outputs the digital signal to the distance calculation unit 40.

When receiving the digital signal from the A/D converter 39, the distance calculation unit 40 converts the digital signal into signals in the frequency domain, as shown in FIG. 12, by, for example, performing the fast Fourier transform (FFT) on the digital signal. FIG. 12 is an explanatory drawing showing an example of the signals in the frequency domain.

The distance calculation unit 40 compares the amplitudes of the signals in the frequency domain and a threshold Th, and detects the frequency of a signal whose amplitude is greater than the threshold Th, out of the signals in the frequency domain, as a peak frequency. Because the interference light detected by the optical detector 38 contains the work surface interference light and the cutting oil interference light as described above, a peak frequency f₁ corresponding to the work surface interference light and t peak frequency f₂ corresponding to the cutting oil interference light are detected. The threshold Th is stored in an internal memory of the distance calculation unit 40. The threshold Th may be provided to the distance calculation unit 40 from the outside.

Here, because the distance from the leading end 21a of the sensor head unit 21 to the cutting oil is shorter than the distance from the leading end 21a of the sensor head unit 21 to the work surface 3a, the magnitude of the peak frequency f₂ is lower than the magnitude of the peak frequency f₁. Namely, the following inequality: f₁>f₂ is established.

When the peak frequency f₁ and the peak frequency f₂ are detected, the distance calculation unit 40 recognizes that the higher one of the peak frequencies f₁ and f₂ is the frequency of the work surface interference light and the lower one of the peak frequencies is the frequency of the cutting oil interference light.

The distance calculation unit 40 calculates the distance L from the leading end 21a of the sensor head unit 21 to the work surface 3a (=L_{Oil}+L_{Depth}) on the basis of the peak frequency f₁ which is the frequency of the work surface interference light and the frequency f₂ of the cutting oil interference light (step ST34).

A process of calculating the distance L_{Oil} from the sensor head unit 21 to the cutting oil using the peak frequency f₂ is expressed by equation (1). In equation (1), the velocity of light is denoted by c, the sweep time of the frequency sweep light source 31a is denoted by Δτ, the sweep band of the frequency sweep light source is denoted by Δv, and a reference frequency at the time that the distance from the sensor head unit 21 is the given distance L₀ is denoted by f₀.

$${L}_{oil} = \frac{c ( {f}_{2} - {f}_{0} ) Δτ}{2 Δ v} + {L}_{0} \qquad ( 1 )$$

A process of calculating the thickness L_{Depth} of the cutting oil is expressed by equation (2) on the basis of the difference between the peak frequency f₁ and the peak frequency f₂, the refractive index n of the cutting oil, the velocity of light c, and the sweep time ττ and the sweep band Av of the frequency sweep light source 31a.

$${L}_{Depth} = \frac{c ( {f}_{1} - {f}_{2} ) Δτ}{2 n Δ v} \qquad ( 2 )$$

The distance calculation unit 40 outputs distance information showing the distance L to the shape calculation unit 75 of the control unit 50 (step ST35).

Returning to FIG. 10, the shape calculation unit 75 calculates the difference between the initial distance L₀ outputted from the coordinate value setting unit 73 and the distance L represented by the distance information outputted from the distance calculation unit 40 as the cutting depth ΔL of the work surface 3a (refer to FIG. 7B), as shown in the following equation (3) (step ST4).

ΔL=L−L₀ (3)

The shape calculation unit 75 extracts the data showing the coordinate values (x, y) of each of the multiple points on the work surface 3a from the shape data (x, y, d) outputted from the coordinate value setting unit 73 and showing the target shape.

The shape calculation unit 75 outputs data containing both the extracted data showing the coordinate values (x, y) of each of the multiple points, and the cutting depth ΔL, as the data (x, y, ΔL) showing the shape of the work surface 3a, to each of the error calculation unit 76 and the three-dimensional data conversion unit 78.

The error calculation unit 76 acquires both the shape data (x, y, d) outputted from the coordinate value setting unit 73 and showing the target shape, and the data (x, y, ΔL) outputted from the shape calculation unit 75 and showing the shape. The error calculation unit 76 compares the shape data (x, y, d) showing the target shape and the data (x, y, ΔL), and calculates an error Δd in the z-axis direction of each of the multiple points on the work surface 3a, as shown in the following equation (4) (step ST5). The error Δd is the error between the cutting depth of the work surface 3a in the target shape and the cutting depth of the work surface 3a after the machining.

Δd=d−ΔL (4)

The error calculation unit 76 outputs error information showing the error Δd in the z-axis direction of each of the multiple points to the display 79.

When receiving the data (x, y, ΔL) showing the shape from the shape calculation unit 75, the three-dimensional data conversion unit 78 stores the data (x, y, ΔL). The three-dimensional data conversion unit 78 stores the pieces of data (x, y, ΔL) about all the points on the work surface 3a.

The three-dimensional data conversion unit 78 converts the pieces of data (x, y, ΔL) about all the points on the work surface 3a into pieces of three-dimensional data, and causes the display 79 to display the work surface 3a in three dimensions in accordance with the pieces of three-dimensional data. Each three-dimensional data is used for three-dimensional rendering.

The display 79 displays the work surface 3a in three dimensions and also displays the error Δd represented by each of the pieces of error information outputted from the error calculation unit 76 (step ST6). By referring to the display 79 displaying the error Id, the user can check, for example, whether or not the machining of the workpiece 3 by the machine tool has been performed properly.

Here, when the input unit 71 receives an instruction to measure the shape of the workpiece 3 from a user, the coordinate value setting unit 73 outputs a control signal to each of the head drive unit 13 and the sensor body unit 22. However, this is only an example, and, for example, when an instruction to measure the shape of the workpiece 3 is received from the outside, the coordinate value setting unit 73 may output a control signal to each of the head drive unit 13 and the sensor body unit 22.

As an alternative, the coordinate value setting unit 73 may output a control signal to each of the head drive unit 13 and the sensor body unit 22 in accordance with a program stored in an internal memory.

In above-described Embodiment 1, the machine tool includes the machining unit 10 for feeding cutting oil to a work surface 3a of the workpiece 3 and machining the work surface 3a, and is configured to include the optical sensor unit 20 for dividing light outputted from the frequency sweep light source 31a for outputting light whose frequency varies periodically into irradiation light with which the workpiece 3 is to be irradiated and reference light, irradiating the workpiece 3 with the irradiation light, detecting a peak frequency of interference light between reflected light which is irradiation light reflected by the workpiece 3, and the reference light, and measuring the distance from the machine tool to the work surface 3a on the basis of the peak frequency, and the shape calculation unit 75 for calculating the shape of the workpiece 3 on the basis of the distance measured by the optical sensor unit 20. Therefore, the machine tool can measure the shape of the workpiece 3 even when the cutting oil remains on the work surface 3a of the workpiece 3.

### Embodiment 2

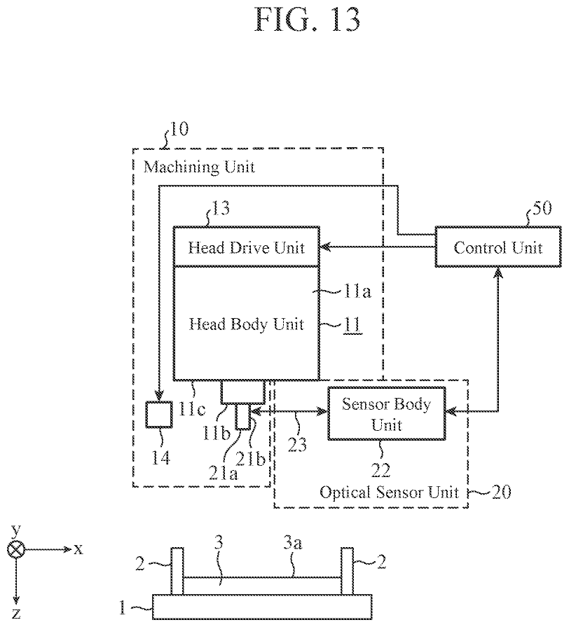

In the machine tool of Embodiment 1, the configuration is provided in which the sensor head unit 21 of the optical sensor unit 20 is mounted on the head body unit 11a. On the other hand, in Embodiment 2, a machine tool is configured in such a way that a sensor head unit 21b is mounted on a spindle lib. FIG. 13 is a schematic diagram showing the machine tool according to Embodiment 2. In FIG. 13, because the same reference signs as those shown in FIG. 1 denote the same components or like components, an explanation of the components will be omitted hereinafter.

In FIG. 13, the spindle 11b of a machining head 11 attachably/detachably holds a machining tool 12 or the sensor head unit 21b. Concretely, when a workpiece 3 is machined, a machining tool 12 is held by the spindle 11b, and when the shape of the workpiece 3 is measured, the sensor head unit 21b is held by the spindle 11b, as shown in FIG. 13.

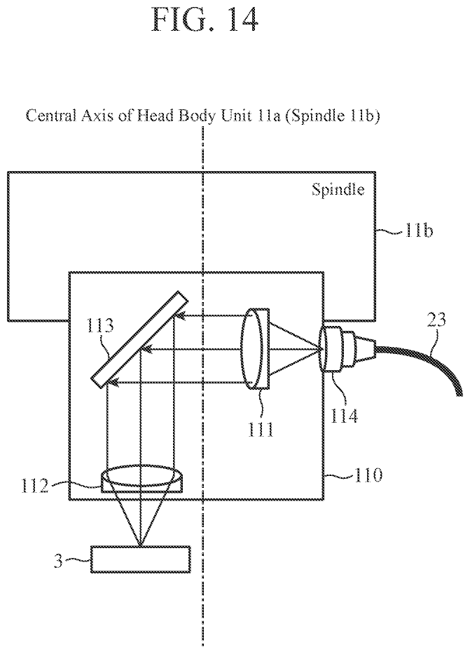

FIG. 14 is a schematic diagram showing the sensor head unit 21b of Embodiment 2. In FIG. 14, the sensor head unit 21b includes a cylindrical-shaped housing 110. The sensor head unit 21b includes two aspheric lenses 111 and 112 as a condensing optical element 35, and a mirror 113 for changing the angle of light emitted from the previous-stage aspheric lens 111 toward the next-stage aspheric lens 112. Further, amounting portion 114 for mounting an optical fiber which is an optical transmission unit 23 is disposed on a side surface of the housing 110.

Because the mounting portion 114 is disposed on the side surface of the housing 110 as described above, irradiation light can be guided to the aspheric lenses 111 and 112 which are the condensing optical element even in a state in which the sensor head unit 21b is fixed to the spindle lib. Further, because the mirror 113 is disposed, the irradiation light incident from the side surface can be made parallel to the central axis of the head body unit 11a and applied to the workpiece 3.

In above-described Embodiment 2, the machine tool is configured in such a way that the sensor head unit 21b is mounted on the spindle 11b. Therefore, the machine tool can hold the sensor head unit 21b by using a chuck device which the spindle 11b has. Therefore, the machine tool can be produced at a low cost without separately disposing a holding mechanism in order to mount the sensor head unit 21b to the machining head 11.

### Embodiment 3

In Embodiment 3, a machine tool includes a tool storage unit 100 for storing multiple machining tools 12 used for machining a work surface 3a. A sensor head unit 21b is also stored in the tool storage unit 100. Then, at the time of machining, a spindle 11b attachably/detachably holds one of the multiple machining tools 12 stored in the tool storage unit 100. At the time of shape measurement, the spindle 11b holds a sensor head unit 21b stored in the tool storage unit 100.

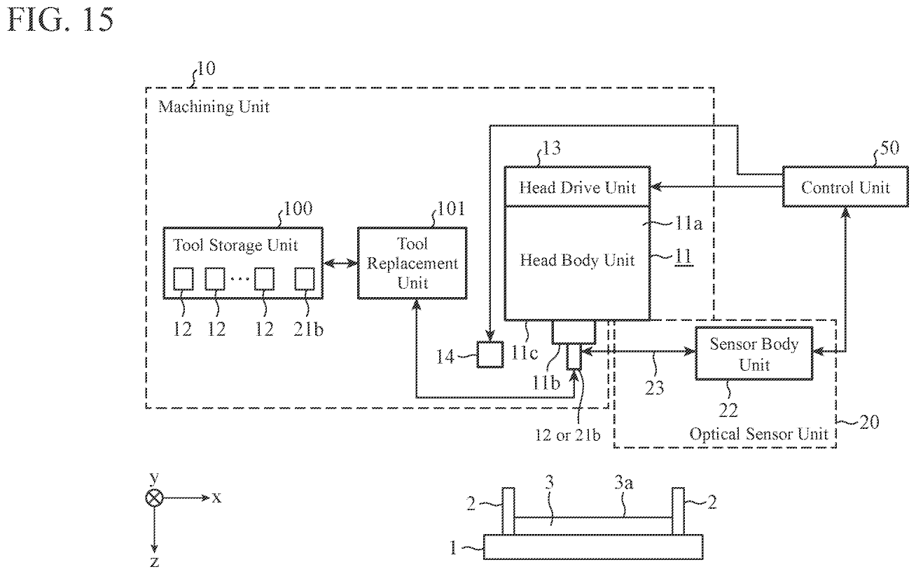

FIG. 15 is a schematic diagram showing the machine tool according to Embodiment 3. In FIG. 15, because the same reference signs as those shown in FIG. 13 denote the same components or like components, an explanation of the components will be omitted hereinafter. The tool storage unit 100 is a rack for storing both the multiple machining tools 12 used for machining the work surface 3a, and the sensor head unit 21b.

A tool replacement unit 101 has a mechanism for replacing the machining tool 12 held by the spindle 11b. At the time of machining, the tool replacement unit 101 selects one of the multiple machining tools 12 stored in the tool storage unit 100, and causes the spindle 11b to hold the selected machining tool 12. On the other hand, at the time of shape measurement, the tool replacement unit 101 selects the sensor head unit 21b stored in the tool storage unit 100, and causes the spindle 11b to hold the selected sensor head unit 21b. Because the mechanism for replacing a machining tool 12 and the sensor head unit 21b is well known, a detailed explanation will be omitted.

In above-described Embodiment 3, the machine tool is configured in such a way that the sensor head unit 21b is stored in the tool storage unit 100 for storing the machining tools 12. Therefore, the machine tool can be produced at a low cost without separately disposing a storage unit in order to store the sensor head unit 21b.

Further, because the sensor head unit 21b stored in the tool storage unit 100 is configured so as to be held by the spindle 11b, the sensor head unit 21b can be handled in the same way that each machining tool 12 is handled. Therefore, the machine tool can be produced at a low cost without separately disposing a holding mechanism in order to mount the sensor head unit 21b to the spindle lib.

### Embodiment 4

In Embodiment 3, the machine tool is configured in such a way that the spindle 11b holds the sensor head unit 21b at the time of measuring a shape. On the other hand, in Embodiment 4, a spindle 11b is configured so as to hold an optical sensor unit 20 at the time of measuring a shape.

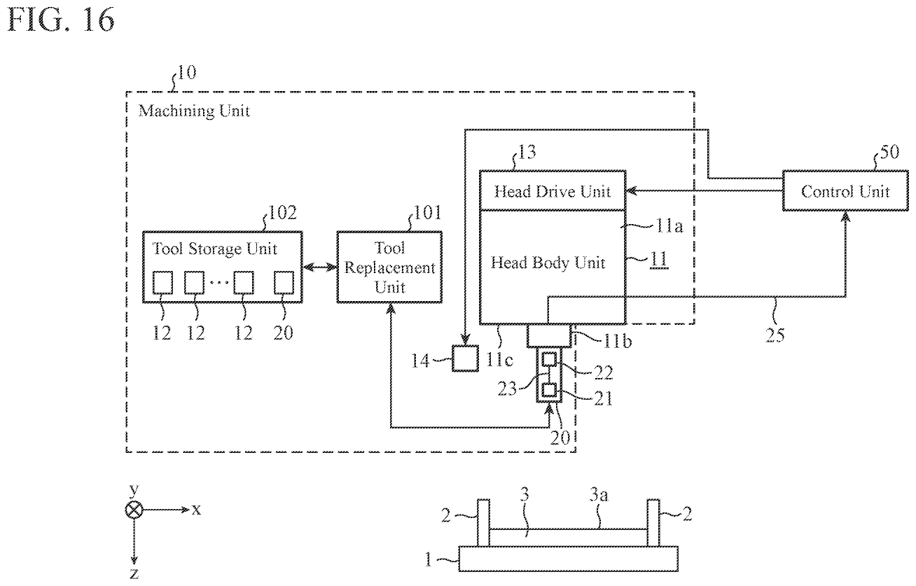

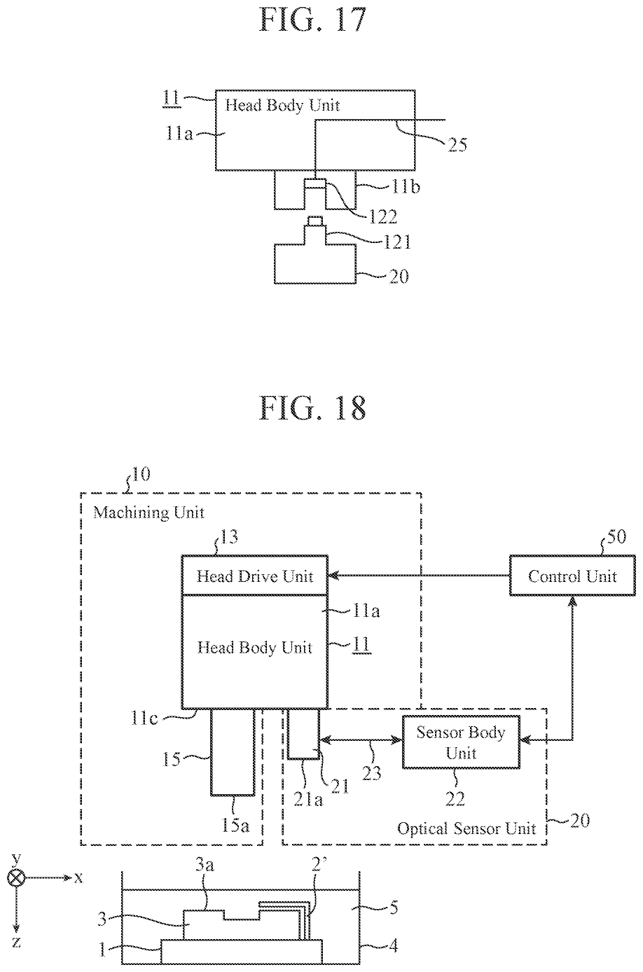

FIG. 16 is a schematic diagram showing a machine tool according to Embodiment 4. As shown in FIG. 16, the optical sensor unit 20 has a sensor head unit 21 and a sensor body unit 22. An electric connection between the optical sensor unit 20 and a machining head 11 will be explained using FIG. 17. FIG. 17 is a partly enlarged view showing the machine tool according to Embodiment 4. As shown in FIG. 17, the optical sensor unit and the spindle 11b have electric connection portions 121 and 122, respectively. The electric connection portions 121 and 122 are defined by, for example, the interface standard in Recommended Standard 232 (RS-232).

A communication cable 25 for transmitting and receiving pieces of information containing distance information, a control signal, and a synchronization signal, which are described before, is connected to the electric connection portion 122 which the spindle 11b has. The communication cable is passed through the insides of the spindle 11b and a head body unit 11a, is led out of the head body unit 11a, and is connected to a control unit 50. Therefore, the machine tool of Embodiment 4 makes it possible to perform transmission and reception of a signal between the control unit 50 and the optical sensor unit 20 through a connection between the electric connection portion 122 of the spindle 11b and the electric connection portion 121 of the optical sensor unit 20.

Returning to FIG. 16, a tool storage unit 102 is a rack for storing both multiple machining tools 12 used for machining a work surface 3a, and the optical sensor unit 20. A tool replacement unit 101 has a mechanism for replacing the machining tool 12 held by the spindle 11b. At the time of machining, the tool replacement unit 101 selects one of the multiple machining tools 12 stored in the tool storage unit 102, and causes the spindle 11b to hold the selected machining tool 12. On the other hand, at the time of shape measurement, the tool replacement unit 101 selects the optical sensor unit 20 stored in the tool storage unit 102, and causes the spindle 11b to hold the selected optical sensor unit 20.

In FIGS. 16 and 17, the same reference signs as those shown in FIG. 15 denote the same components or like components.

In above-described Embodiment 4, the machine tool is configured in such a way that the optical sensor unit 20 is stored in the tool storage unit 102 for storing the machining tools 12. Therefore, the machine tool can be produced at a low cost without separately disposing a storage unit in order to store the optical sensor unit 20.

Further, because the optical sensor unit 20 stored in the tool storage unit 102 is configured so as to be held by the spindle 11b, the optical sensor unit 20 can be handled in the same way that each machining tool 12 is handled. Therefore, the machine tool can be produced at a low cost without separately disposing a holding mechanism in order to mount the optical sensor unit 20 to the spindle 11b.

In addition, because the communication cable 25 between the control unit 50 and the optical sensor unit 20 is configured so as to be passed through the inside of the head body unit 11a, the communication cable 25 can be prevented from being broken when the machining head 11 moves.

In the machine tool according to Embodiments 1 to 4, the machining unit 19 feeds cutting oil to the work surface 3a of the workpiece 3.

However, as the oil which the machining unit 19 feeds to the work surface 3a, any liquid used for, as a main purpose, the prevention of the wearing away of a tool, the wearing away being accompanied by metal processing, or the prevention of rise in the temperature of a tool, the temperature rise being accompanied by metal processing, can be used, and is not limited to cutting oil. The liquid used for such a main purpose is called machining oil, and cutting oil is included in the machining oil. Electric discharge oil which will be mentioned later, or the like is included in the machining oil.

Embodiment 5.

In Embodiments 1 to 4, the machine tool having the optical sensor unit 20 is explained.

In Embodiment 5, an electric discharge machining apparatus having an optical sensor unit 20 will be explained.

FIG. 18 is a schematic diagram showing the electric discharge machining apparatus according to Embodiment 5. In FIG. 18, because the same reference signs as those shown in FIG. 1 denote the same components or like components, an explanation of the components will be omitted hereinafter.

The electric discharge machining apparatus shown in FIG. 18 measures the distance from the electric discharge machining apparatus to a work surface 3a by using an electrode 15 mounted on a machining head 11, and calculates the shape of a workpiece 3 on the basis of the measured distance.

A vice 2′ is a fixture for fixing the workpiece 3 so that the workpiece 3 does not move at the time of machining the workpiece 3.

A work tank 4 is a container for storing electric discharge oil 5 which is machining oil. Each of a table 1 and the workpiece 3 is contained in the work tank 4 in such a way that the whole of each of the parts is immersed in the electric discharge oil 5.

The electrode 15 is mounted on an outer surface 11c facing the table 1, out of multiple outer surfaces which a head body unit 11a has. The electrode 15 has a leading end portion 15a from which the electrode emits electrons. By applying a voltage between the leading end portion 15a and the work surface 3a of the workpiece 3, the electrode 15 causes sparks to occur by means of electric discharge. Because the work surface 3a is scraped by the occurrence of sparks, machining of the workpiece 3 can be performed. As the electrode 15, a high-conductivity material such as copper or graphite is used.

Also in the electric discharge machining apparatus shown in FIG. 18, the optical sensor unit 20 calculates the distance from a leading end 21a of a sensor head unit 21 to the work surface 3a of the workpiece 3 and calculates the shape of the workpiece 3 on the basis of the calculated distance, like in the machine tool shown in FIG. 1.

When the optical sensor unit 20 calculates the distance, the sensor head unit 21 applies irradiation light outputted from a sensor body unit 22 to the work surface 3a, like that of Embodiment 1. The sensor head unit 21 receives reflected light containing both reflected light which is irradiation light reflected by the work surface 3a and reflected light which is irradiation light reflected by the electric discharge oil 5. The sensor head unit 21 outputs the reflected light received thereby to the sensor body unit 22.

When a machining unit 10 machines the work surface 3a, the whole of the workpiece 3 needs to be immersed in the electric discharge oil 5. On the other hand, when the optical sensor unit 20 calculates the distance, it does not matter whether or not the work surface 3a of the workpiece 3 is immersed in the electric discharge oil 5. Therefore, the optical sensor unit may calculate the distance in a state in which the work surface 3a of the workpiece 3 is not immersed in the electric discharge oil 5, by moving the table 1 in the negative direction of the z axis using an actuator or the like which is not illustrated.

In above-described Embodiment 5, the electric discharge machining apparatus includes the machining unit 10 for machining the work surface 3a of the workpiece 3 immersed in machining oil, and is configured so as to include: the optical sensor unit 20 for dividing light outputted from a frequency sweep light source 31a for outputting light whose frequency varies periodically within a single frequency band into irradiation light with which the workpiece 3 is to be irradiated and reference light, irradiating the workpiece 3 with the irradiation light, detecting a peak frequency of interference light between reflected light which is irradiation light reflected by the workpiece 3, and the reference light, and measuring the distance from the electric discharge machining apparatus to the work surface 3a on the basis of the peak frequency; and a shape calculation unit 75 for calculating the shape of the workpiece 3 on the basis of the distance measured by the optical sensor unit 20. Therefore, the electric discharge machining apparatus can measure the shape of the workpiece 3 even when the machining oil remains on the work surface 3a of the workpiece 3.

It is to be understood that any combination of two or more of the above-described embodiments can be made, various changes can be made in any component according to any one of the above-described embodiments, or any component according to any one of the above-described embodiments can be omitted within the scope of the present invention.

### INDUSTRIAL APPLICABILITY

The present invention is suitable for machine tools and electric discharge machining apparatuses which machine a work surface of a workpiece.

### REFERENCE SIGNS LIST

1 table, 2, 2′ vice, 3 workpiece, 3a work surface, 4 work tank, 5 electric discharge oil, 10 machining unit, 11 machining head, 11a head body unit, 11b spindle (tool holding unit), 11c outer surface, 12 machining tool, 13 head drive unit, 14 cutting oil nozzle, 15 electrode, 15a leading end portion, 20 optical sensor unit, 21, 21b sensor head unit, 21a leading end, 22 sensor body unit, 23 optical transmission unit, 25 communication cable, 31 frequency sweep light output unit, 31a frequency sweep light source, 32 optical dividing unit, 33 optical coupler, 34 circulator, 35 condensing optical element, 36 optical interference unit, 37 optical interferometer, 38 optical detector, 39 A/D converter, 40 distance calculation unit, 50 control unit, 61 memory, 62 processor, 71 input unit, 72 storage device, 73 coordinate value setting unit, 74 cutting oil feed unit, 75 shape calculation unit, 76 error calculation unit, 77 display processing unit, 78 three-dimensional data conversion unit, 79 display, 81 coordinate value setting circuit, 82 cutting oil feed circuit, 83 shape calculation circuit, 84 error calculation circuit, 85 three-dimensional data conversion circuit, 91 memory, 92 processor, 100, 102 tool storage unit, 101 tool replacement unit, 110 housing, 111, 112 aspheric lens, 113 mirror, 114 mounting portion, and 121, 122 electric connection portion.

1. A machine tool including a machining unit for feeding cutting oil to a work surface of a workpiece and machining the work surface, the machine tool comprising:
an optical sensor unit dividing light outputted from a frequency sweep light source for outputting light whose frequency varies periodically into irradiation light with which the workpiece is to be irradiated and reference light, irradiating the workpiece with the irradiation light, detecting a peak frequency of interference light between reflected light which is irradiation light reflected by the workpiece, and the reference light, and measuring a distance from the machine tool to the work surface on a basis of the peak frequency; and
a shape calculation unit calculating a shape of the workpiece on a basis of the distance measured by the optical sensor unit.

2. The machine tool according to claim 1, wherein the interference light contains first interference light which is interference light between reflected light from the work surface of the workpiece and the reference light, and second interference light which is interference light between reflected light from the cutting oil and the reference light, and
the optical sensor unit calculates the distance from the machine tool to the work surface on a basis of a peak frequency of the first interference light and a peak frequency of the second interference light.

3. The machine tool according to claim 2, wherein the optical sensor unit distinguishes the peak frequency of the first interference light and the peak frequency of the second interference light on a basis of magnitude of the peak frequency of the first interference light and magnitude of the peak frequency of the second interference light.

4. The machine tool according to claim 3, wherein the optical sensor unit measures the distance from the machine tool to the work surface on a basis of both a distance from the machine tool to the cutting oil and a thickness of the cutting oil.

5. The machine tool according to claim 1, wherein the machining unit includes:
a tool holding unit to hold a machining tool for machining the work surface;
a head body unit to hold the tool holding unit; and
a head drive unit to change a position of the head body unit relatively with respect to a table on which the workpiece is placed, and
the shape calculation unit calculates the shape of the workpiece on a basis of both the position of the head body unit, the position being changed by the head drive unit, and the distance measured by the optical sensor unit.

6. The machine tool according to claim 1, wherein the machining unit includes:
a tool holding unit to hold a machining tool for machining the work surface; and
a head body unit to hold the tool holding unit,
wherein a part of the optical sensor unit is mounted on the head body unit.

7. The machine tool according to claim 6, wherein a sensor head unit having a condensing optical element is mounted, as the part of the optical sensor unit, on the head body unit.

8. The machine tool according to claim 7, wherein the machine tool comprises a table having a surface on which the workpiece is placed, and
the sensor head unit is mounted on an outer surface facing the surface on which the workpiece is placed, out of multiple outer surfaces which the head body unit has.

9. The machine tool according to claim 1, wherein the machining unit comprises:
a tool holding unit to hold a machining tool for machining the work surface; and
a head body unit to hold the tool holding unit,
wherein a part of the optical sensor unit is held by the tool holding unit.

10. The machine tool according to claim 9, wherein a sensor head unit having a condensing optical element is held, as the part of the optical sensor unit, by the tool holding unit.

11. The machine tool according to claim 1, wherein the machining unit comprises a tool storage unit storing multiple machining tools used for machining the work surface, and
a part of the optical sensor unit is stored in the tool storage unit.

12. The machine tool according to claim 1, wherein the machining unit comprises:
a tool holding unit to hold a machining tool for machining the work surface; and
a head body unit to hold the tool holding unit,
wherein the optical sensor unit is held by the tool holding unit.

13. The machine tool according to claim 1, wherein the machining unit comprises a tool storage unit storing multiple machining tools used for machining the work surface, and
the optical sensor unit is stored in the tool storage unit.

14. The machine tool according to claim 1, wherein the machining unit comprises:
a tool holding unit to hold a machining tool for machining the work surface; and
a head body unit to hold the tool holding unit,
wherein a communication cable for outputting information containing the distance measured by the optical sensor unit to an outside is passed through an inside of the head body unit and is led out of the head body unit.

15. The machine tool according to claim 1, wherein the machining unit comprises a cutting oil nozzle feeding the cutting oil to the work surface.

16. A machine tool including a machining unit for feeding machining oil to a work surface of a workpiece, and machining the work surface, the machine tool comprising:
an optical sensor unit dividing light outputted from a frequency sweep light source for outputting light whose frequency varies periodically within a single frequency band into irradiation light with which the workpiece is to be irradiated and reference light, irradiating the workpiece with the irradiation light, detecting a peak frequency of interference light between reflected light which is irradiation light reflected by the workpiece, and the reference light, and measuring a distance from the machine tool to the work surface on a basis of the peak frequency; and
a shape calculation unit calculating a shape of the workpiece on a basis of the distance measured by the optical sensor unit.

17. An electric discharge machining apparatus including a machining unit for machining a work surface of a workpiece immersed in machining oil, the electric discharge machining apparatus comprising:
an optical sensor unit dividing light outputted from a frequency sweep light source for outputting light whose frequency varies periodically within a single frequency band into irradiation light with which the workpiece is to be irradiated and reference light, irradiating the workpiece with the irradiation light, detecting a peak frequency of interference light between reflected light which is irradiation light reflected by the workpiece, and the reference light, and measuring a distance from the electric discharge machining apparatus to the work surface on a basis of the peak frequency; and
a shape calculation unit calculating a shape of the workpiece on a basis of the distance measured by the optical sensor unit.
